(19) United States
(12) Patent Application Publication
(10) Pub. No.: US 2003/0160891 A1
(43) Pub. Date: Aug. 28, 2003

(54) Image-pickup apparatus and method of reproducing images

(76) Inventor: Masaki Mikamo, Kanagawa (JP)

Correspondence Address: William S Frommer, Frommer Lawrence & Haug, 745 Fifth Avenue, NEW YORK,, NY, 10151, US

(21) Appl. No.: 10/239,528

(22) PCT Filed: Dec. 27, 2001
(86) PCT No.: PCT/JP02/00473

(51) Int. Cl. H04N 5/225; G03B 13/00

(52) U.S. Cl. 348/375; 348/376; 348/333.06; 348/220.1; 348/345; 348/222.1

(57) ABSTRACT

In a camera-incorporating VTR (1), the camera-signal processing circuit (5) performs a camera-signal process on a video signal output from an imager (4). The recording circuit (7) receives an image signal from the camera-signal processing circuit (5) and records the signal on a video tape. The reproducing circuit (8) reproduces the image signal recorded on the videotape by the recording circuit (7). The microprocessor (9) causes the focus ring (3) mounted on the optical lens (2) to function as a speed-changing ring to change the speed of reproducing the image signal. The VTR (1) remains small and can yet enable the user to edit data with a high efficiency.

### TECHNICAL FIELD

The present invention relates to an image-pickup apparatus which picks up an image of an object through an optical lens by using an image-pickup element and which uses the rotary ring mounted on the optical lens to reproduce an image signal at various speeds or to select an image signal. The invention also relates to a method of reproducing images, in which the rotary ring mounted on an optical lens to reproduce an image signal at various speeds or to select an image signal, in the process of reproducing the image signal recorded on a medium.

### BACKGROUND ART

Video cameras have come to have technical editing functions. To extract desired scenes, a video camera needs to have a forward frame-feeding button, a reverse frame-feeding button, a jog-shuttle key, and the like. The jog-shuttle key is a dial-type operation key that performs a shuttle-edit function and a jog-dial function. The shuttle-edit function is to change the speed of reproducing images in accordance with the angle through which a rotary unit is rotated around a specific axis. The jog-dial function is to feed frames of image in the forward or reverse direction in accordance with the direction in which the rotary unit is rotated.

Video cameras are getting smaller and smaller. They are now not so large that the jog-shuttle key should be mounted on the housing.

If the jog-shuttle key is mounted on a remote controller, the remote controller will inevitably grow large. If it is mounted on the housing of a video camera, the video camera will become large. In other words, the video camera cannot be as small as is desired. If the remote controller becomes large due to the jog-shuttle key provided on it, it can hardly be carried along with the video camera. Being large, the remote controller diminishes the commercial value of the video camera, which is supposed to “photograph” objects.

To incorporate the forward frame-feeding function and the reverse frame-feeding function in a small housing, both functions must be provided in the form of buttons. It takes very much time to operate buttons to feed the moving picture, frame by frame. It is therefore desired that a jog-shuttle key be mounted on the housing.

The demand for a small video camera and the demand for an easy-to-operate video camera conflict each other. It has been difficult to meet these mutually conflicting demands.

### DISCLOSURE OF THE INVENTION

The present invention has been made in consideration of the situation described above. An object of the invention is to provide an image-pickup apparatus which is small and with which it is far easier to edit data.

Other objects of the invention and specific advantages that the invention attains will be more apparent from the following description of embodiments.

### BRIEF DESCRIPTION OF THE DRAWINGS

FIG. 1 is a block diagram of a camera-incorporated VTR that is an embodiment of the present invention;

FIG. 2 is a perspective view of the camera-incorporated VTR, with the LCD panel turned toward the viewfinder;

FIG. 3 is a perspective view of the camera-incorporated VTR, with the LCD panel turned away from the viewfinder;

FIG. 4 is a diagram showing the circuit with a ring, which is provided in the camera-incorporated VTR;

FIG. 5 is a flowchart explaining an operating mode of the camera-incorporated VTR;

FIG. 6 is a diagram depicting the power-supply switch provided at a prescribed position on the housing of the camera-incorporated VTR;

FIG. 7 is a diagram illustrating the focus switch provided at a prescribed position on the housing of the camera-incorporated VTR;

FIG. 8 is a diagram explaining how the focus ring is operated to perform the shuttle-edit function;

FIG. 9 is a diagram explaining how the focus ring is operated to perform the jog-dial function;

FIG. 10 is a diagram explaining a control that maintains the speed-changing ring function while images are being reproduced or an image is being halted;

FIGS. 11A and 11B are diagrams explaining how the control of the ring function is changed in accordance with the center position;

FIG. 12 is a flowchart explaining another operating mode of the camera-incorporated VTR; and

FIGS. 13A and 13B show the major components of a modification of the camera-incorporated VTR, in which the focus ring operates in interlock with the cap for the optical lens.

### BEST MODE FOR CARRYING OUT THE INVENTION

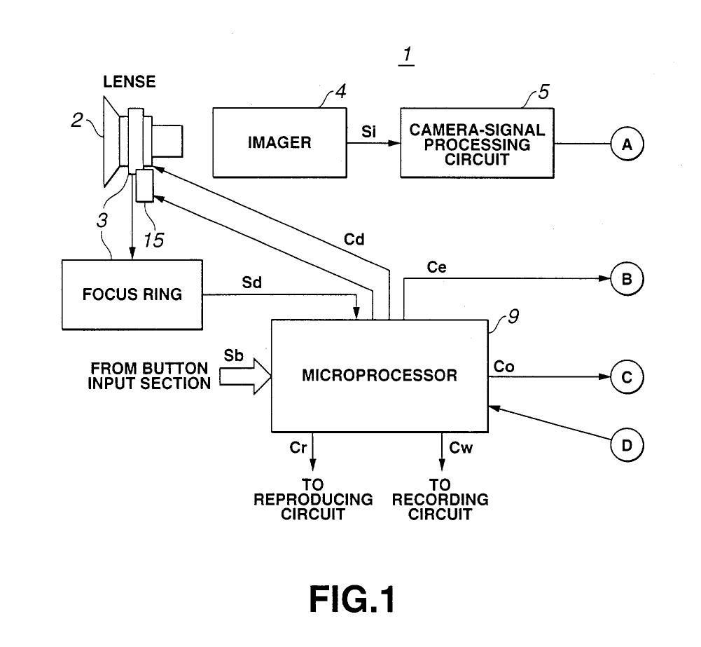

An embodiment of the present invention will be described, with reference to the accompanying drawings. As is shown in FIG. 1, the embodiment is a VTR 1 that incorporates a camera. The VTR 1 comprises an optical lens 2, a focus ring 3, a CCD image sensor (imager) 4, a camera-signal processing circuit 5, a recording circuit 7, a reproducing circuit 8, and a microprocessor 9. The focus ring 3 operates in interlock with the optical lens 2. The imager 4 receives an image of an object via the optical lens 2 and generates a video signal from the image. The camera-signal processing circuit 5 performs camera-signal process on the video signal output from the imager 4, thereby generating an image signal. The recording circuit 7 records, on videotape, the image signal supplied from the camera-signal processing circuit 5. The reproducing circuit 8 reproduces the image signal from the videotape. The microprocessor 9 causes the focus ring 3 to function as a speed-changing ring that changes the speed at which the image signal is reproduced.

The camera-incorporated VTR 1 further comprises a switching section 6 that is provided between the camera-signal processing circuit 5 and the recording circuit 7. The section 6 selects either an image signal supplied from an on-screen display circuit 10 (later described) or an image signal supplied from camera-signal processing circuit 5. The section 6 supplies the image signal selected, to the recording circuit 7. Still further, the camera-incorporated VTR 1 comprises a switching section 11, a switching section 12, and an LCD panel 13. The switching section 11 selects either an image signal supplied from the camera-signal processing circuit 5 or an image signal supplied from the reproducing circuit 8. The switching section 12 selects either an image signal supplied from the switching section 11 or an image signal supplied from the on-screen display circuit 10. The LCD panel 13 display the image represented by the image signal selected by the switching section 12.

The camera-incorporated VTR 1 comprises an on-screen display circuit 10, too. The on-screen display circuit 10 is provided between the microprocessor 9 and the LCD panel 13 and controls the LCD panel 13. Moreover, the camera-incorporated VTR 1 comprises a ring-load circuit 15 that makes the user to feel a “click” when the focus ring 3 is operated as speed-changing ring.

The optical lens 2 is an image-pickup lens. The focus ring 3, or a rotary ring, is mounted on the optical lens 2. The focus ring 3 is rotated to bring the object into focus in picking up an image of the object. As will be described later, the camera-incorporated VTR 1 has a switch that the user may operate to select automatic focusing or manual focusing. When the manual focusing is selected, the user can manually adjust the focus.

The imager 4 comprises a CCD solid-state image-pickup element that has a colors-separating prism. The imager 4 receives image light from the object via the optical lens 2 and converts the light into an imager signals Si, such as a red signal R, a green signal G and a blue signal B. The imager signals Si are output to the camera-signal processing circuit 5.

The camera-signal processing circuit 5 performs camera-signal processes on the imager signals Si. Among the camera-signal processes are image enhancing (IE) process, matrix process, gamma process and knee process. The image-enhancing process is an outline-emphasizing process (known as “detail process”). Upon performing these camera-signal processes, the camera-signal processing circuit 5 generates an image signal. The image signal is supplied to the signal-selecting terminal a of the switching section 6.

The switching section 6 has another signal-selecting terminal b and a movable terminal c. The movable terminal c is connected to either the signal-selecting terminal a or the signal-selecting terminal b, thereby to supply the image signal supplied to the terminal a or the terminal b, to the recording circuit 7. Note that the signal-selecting terminal b receives the image signal from the on-screen display circuit 10.

The recording circuit 7 comprises a signal-processing section and a mechanical section. The signal-processing section processes signals before the signals are recorded. The mechanical section drives the videotape, the rotary drum, and the magnetic head arranged at the rotary drum. The circuit 7 receives an image signal from the switching section 6, i.e., an image signal supplied from the camera-signal processing circuit 5 or an image signal supplied from the on-screen display circuit 10. The circuit 7 processes the image signal so that the image signal may be recorded. The image signal thus processed is recorded on the videotape. The recording circuit 7 receives a control signal Cw from the microprocessor 9 and processes the image signal in accordance with the control signal Cw.

The reproducing circuit 8 constitutes the VTR, jointly with the recording circuit 7. The circuit 8 shares the magnetic head and mechanical section with the recording circuit 7. (The magnetic head is arranged at the rotary drum.) The circuit 8 reproduces the image signal that the recording circuit 7 has recorded on the videotape. The reproducing circuit 8 receives a control signal Cr from the microprocessor 9. In accordance with the control signal Cr, the circuit 8 performs a signal-reproducing process, e.g., playback or fast tape feeding. The reproducing circuit 8 receives a control signal Ce, too, from the microprocessor 9. In accordance with this control signal Ce, the circuit 8 can reproduce the image signal recorded on the videotape, at various speeds. The image signal Sv reproduced by the reproducing circuit 8 is supplied to the signal-selecting terminal a (VTR) of the switching section 11.

The switching section 11 has another signal-selecting terminal b and a movable terminal c. The movable terminal c is connected to either the signal-selecting terminal a or the signal-selecting terminal b, thereby to supply the image signal supplied to the terminal a or the terminal b, to the signal-selecting terminal a of the switching circuit 12. Note that the signal-selecting terminal b of the switching circuit 11 receives the image signal from the camera-signal processing circuit 5.

The switching section 12 has another signal-selecting terminal b and a movable terminal c. The movable terminal c is connected to either the signal-selecting terminal a or the signal-selecting terminal b, thereby to supply the image signal supplied to the terminal a or the terminal b, to the LCD panel 13. The signal-selecting terminal b of the switching circuit 12 receives the image signal from the on-screen display circuit 10.

The LCD panel 13 is connected to the housing of the camera-incorporated VTR 1 through a connecting section. The LCD panel can be rotated in at least two directions, i.e., forward direction and reverse direction, as will be described later in detail. It displays the image represented by an image signal Sc supplied from the camera-signal processing circuit 5, an image signal Sv supplied from the reproducing circuit 8, or an image signal So supplied from the on-screen display circuit 10. The image displayed on the LCD panel 13 is displayed also on the viewfinder that is provided on the housing. The LCD panel 13 can therefore be used as a viewfinder. The rotation of the LCD panel 13 is detected by a panel-mirror detecting circuit 14. Upon detecting the rotation, the circuit 14 generates a detection signal, which is supplied to the microprocessor 9.

The microprocessor 9 receives button signals Sb generated as the user pushes the power-supply switch, focus switch, reproduction switch button, fast-feeding switch button and recording switch button. Upon receiving button signals Sb, the microprocessor 9 generates various control signals. The control signals are supplied to the other components of the VTR 1, controlling them. More specifically, the microprocessor 9 supplies the control signal Cw to the recording circuit 7, thus controlling the recording of signals, and supplies the control signal Cr to the reproducing circuit 8, thereby controlling the reproducing of signals, as described above. Further, the microprocessor 9 supplies the control signal Ce to the reproducing circuit 8, too. The signal Ce controls the speed of reproducing signals to edit video data, thus controlling, for example, the jog-shuttle function. Further, the microprocessor 9 supplies a display control signal Co to the on-screen display circuit 10 so that the operating state of the VRT 1 and various guidance messages may be displayed.

The microprocessor 9 supplies a control signal Cd for driving the lens in the rotation of the focus ring 3. The microprocessor 9 detects a signal Sd that indicates the rotation of the focus ring 3. The microprocessor 9 can therefore generates the control signal Cd for driving the lens.

The microprocessor 9 determines whether it should make the focus ring 3 perform the speed-changing ring function, from the signal supplied from the power-supply key through the button-input circuit. The microprocessor 9 may detect the activation of the reproducing circuit 8 to implement the speed-changing ring function. The microprocessor 9 carries out focus adjustment in accordance with the rotation of the focus ring 3 in the image-pickup mode, causing the imager 4 to generate the data representing the image of the object supplied via the optical lens 2.

Moreover, the microprocessor 9 activates the ring-load circuit 15 to make the focus ring 3 operate as a speed-changing ring. That is, the ring-load circuit 15 applies a mechanical or electrical load on the focus ring 3, whereby the user can feel a “click.” The operation of the microprocessor 9, described above, will be explained later in detail.

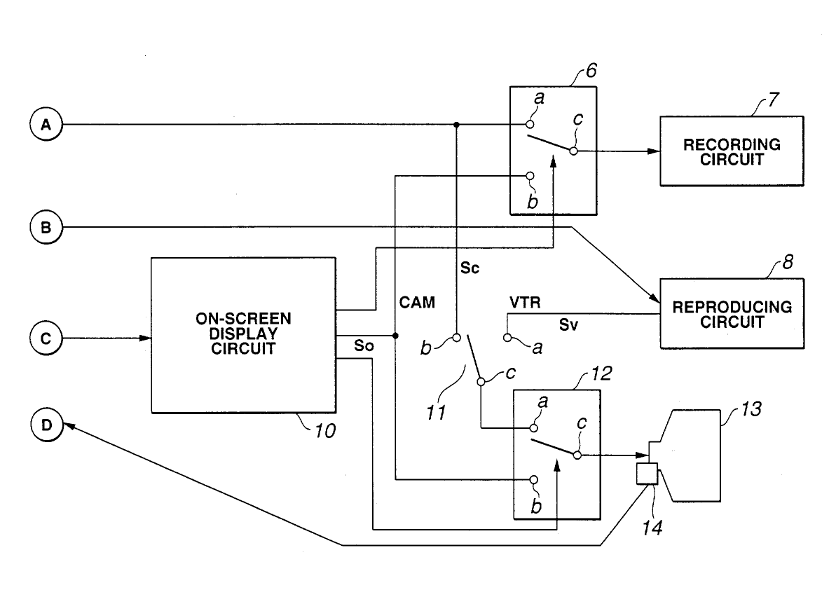

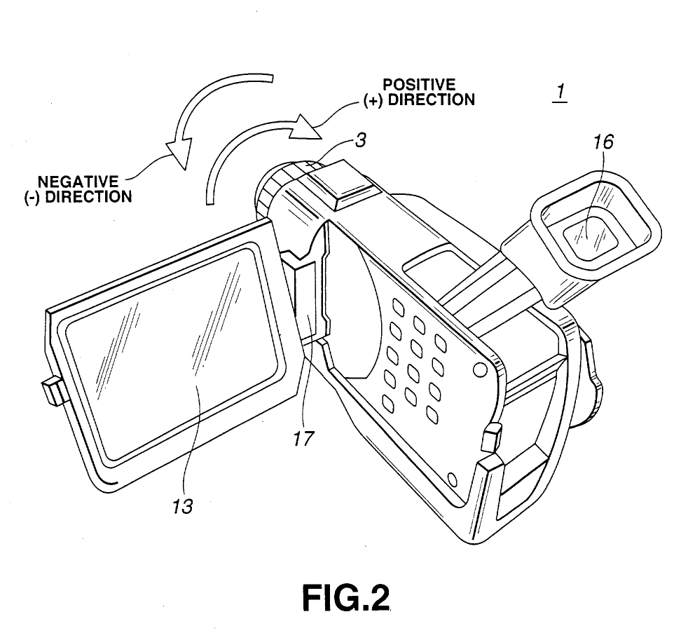

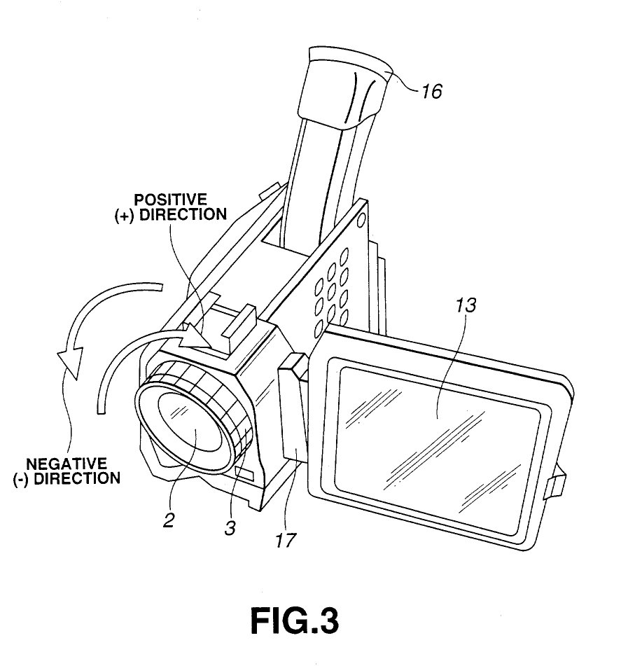

FIGS. 2 and 3 illustrate the outer appearance of the camera-incorporated VTR 1. FIG. 2 is a perspective view, showing the LCD panel 13 turned toward the viewfinder 16. As indicated earlier, the LCD panel 13 can rotate in at least two directions, i.e., forward direction and reverse direction around the joint 17 that couples the panel 13 with the housing. If the LCD panel 13 is said to rotate in the forward direction to assume the position shown in FIG. 2, it is rotated in the reverse direction to take the position depicted in FIG. 3. The LCD panel 13 can, of course, be tilt up and down around the joint 17.

In the camera-incorporated VTR 1, the panel-mirror detecting circuit 14 detects the direction in which the LCD panel 13 has been rotated. In accordance with the direction detected by the circuit 14, the microprocessor 9 changes the direction in which to rotate the focus ring 3 operating as speed-changing ring.

Assume that the LCD panel 13 has been rotated, for example, in the forward direction as is illustrated in FIG. 2. Then the speed-changing ring (focus ring) 3 is said to be rotated in a positive (+) direction if it is rotated clockwise, and in a negative (−) direction if it is rotated counterclockwise. If the signal Sd indicates that the ring 3 has been rotated in the positive (+) direction, the microprocessor 9 instructs the reproducing circuit 8 to reproduce an image signal at an increased speed. Conversely, if the signal Sd indicates that the ring 3 has been rotated in the negative (−) direction, the microprocessor 9 instructs the reproducing circuit 8 to reproduce an image signal at a decreased speed.

Assume that the LCD panel 13 has been rotated, for example, in the reverse direction as is illustrated in FIG. 3. Then the speed-changing ring (focus ring) 3 is said to be rotated in the positive (+) direction if it is rotated clockwise, and in the negative (−) direction if it is rotated counterclockwise. If the signal Sd indicates that the ring 3 has been rotated in the positive (+) direction, the microprocessor 9 instructs the reproducing circuit 8 to reproduce an image signal at an increased speed. Conversely, if the signal Sd indicates that the ring 3 has been rotated in the negative (−) direction, the microprocessor 9 instructs the reproducing circuit 8 to reproduce an image signal at a decreased speed.

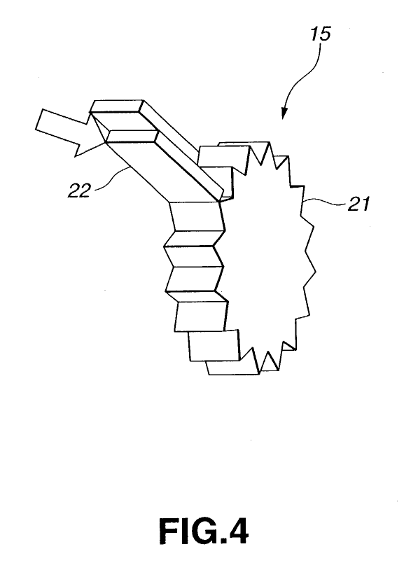

FIG. 4 depicts an example of the ring-load circuit 15. The example is a mechanical load. It comprises a ring gear 21 and a tongue 22. The ring gear 21 is directly coupled with the focus ring 3 and rotates in the same direction as the focus ring 3 is rotated. The tongue 22 remains spaced apart from the ring gear 21, exerting no load on the gear 21, as long as the focus ring 3 is used to bring the object into focus. To use the focus ring 3 as a speed-changing ring in reproducing an image signal, the tongue 22 is moved to contact the ring gear 21 under the control of the microprocessor 9. Once set in contact with the ring gear 21, the tongue 22 applies a load on the ring gear 21. The method of applying a mechanical load or an electrical load is known in the art. The microprocessor 9 causes the ring-load circuit 15 to exert a load on the focus ring 3 for making the user to feel a “click” in the playback mode only. This characterizes the present embodiment.

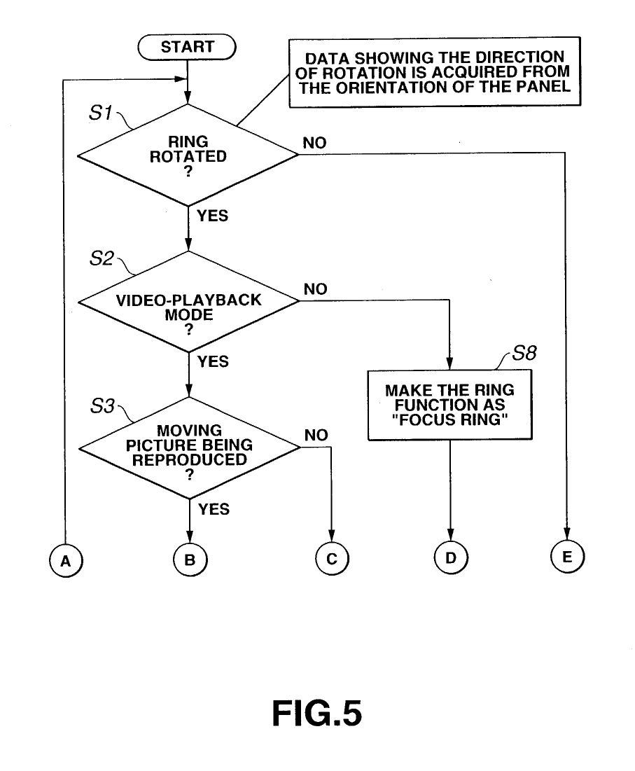

The sequence of operation that the camera-incorporated VTR 1 performs will be explained, with reference to the flowchart of FIG. 5, FIGS. 1 to 4 and FIGS. 6 to 11. FIG. 5 illustrates the control sequence that the microprocessor 9 carries out.

First, the microprocessor 8 determines in Step S1 whether the focus ring 3 has been rotated or not. If the focus ring 3 is found rotated, the operation goes to Step S2. As pointed out earlier, the microprocessor 9 has the information showing the direction in which the LCD panel 13 has been rotated. Alternatively stated, the microprocessor 9 has received an output signal of the panel-mirror detecting circuit 14.

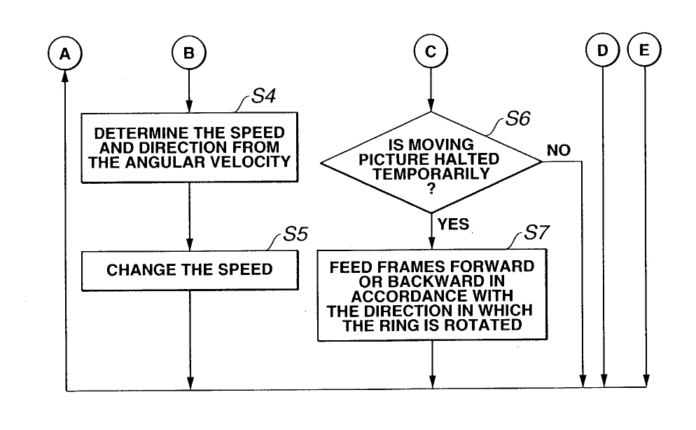

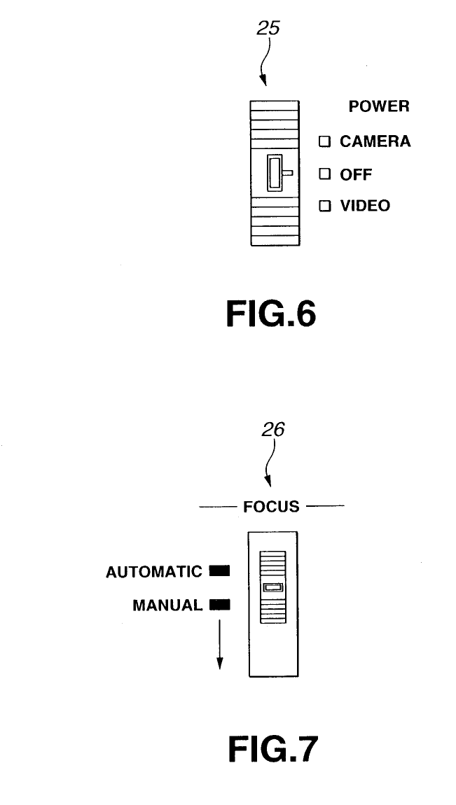

The operation goes to Step S2. In Step S2, the microprocessor 9 determines whether the VTR 1 assumes the video-playback mode or not. The camera-incorporated VTR 1 has a power-supply switch 25 shown in FIG. 6, which is provided at a specific position on the housing of the VTR 1. The power-supply switch 25 may be operated to select three power-supply modes, which are camera mode, off-mode and video mode. Since the camera-incorporated VTR 1 is a portable one, it uses a battery as power supply. To reduce the consumption of battery power, no power is supplied to any component that need not be used for a necessary operation. When the power-supply switch 25 is operated, setting the VTR 1 in the video mode, the microprocessor 9 determines in Step S2 that video-playback mode has been selected. The operation then advances to Step S3.

In Step S3, the microprocessor 9 determines whether the VTR 1 is ready to reproduce the moving picture. This is achieved in accordance with whether the button signal Sb supplied from the button input section instructs that the videotape be played back. If YES in Step S3, the operation goes to Step S4. In Step S4, the microprocessor 9 performs a process to supply a control signal Ce to the reproducing circuit 8 so that the image signal be reproduced at a different speed, because the rotation of the focus ring 3 has been detected in Step S1.

That is, the microprocessor 9 makes the focus ring 3 function as the speed-changing ring if the focus ring 3 is rotated after the power-supply switch has selected the video-playback mode to reproduce the moving picture. At this time, the speed-changing ring is rotated in the reverse direction in accordance with the direction in which the LCD panel 13 is rotated.

In Step S4, a new speed and direction of reproducing the image signal are determined from the angular velocity of the focus ring 3 that functions as a speed-changing ring. A control signal Ce for the new speed is generated and supplied to the reproducing circuit 8. In Step S5, the playback speed is changed. More precisely, the speed of reproducing the image signal is changed in accordance with the angular velocity of the rotary ring. This change of speed is called “shuttle-edit function.” When Step S5 is completed, the operation returns to Step S1.

In Step S3 the microprocessor 9 may determine that the VTR 1 is not ready to reproduce the moving picture. In this case, the operation goes to Step S6. In Step S6, the microprocessor 9 determines whether the moving-picture reproduction is temporarily interrupted or not. If YES in Step S6, the operation advances to Step S7. In Step S7, the moving picture is fed forward or backward, frame by frame, in accordance with the direction in which the rotary ring is rotated. That is, the user rotates the ring to feed the picture, either forward or backward. This feeding of the moving picture is called “jog-dial function.” When Step S7 is completed or when the microprocessor 9 determines in Step S6 that the moving-picture reproduction is not interrupted, the operation returns to Step S1.

In Step S2 it may be determines that the VTR 1 does not assume the video-playback mode. In this case, the power-supply switch 25 selects the camera mode unless it selects the off-mode, as can be seen from FIG. 6. Thus, the operation goes to Step S8. In Step S8, the focus ring 3 is used to adjust the focus. FIG. 7 shows a focus switch 26 that can be operated to select an automatic focusing mode or a manual-focusing mode. If the switch has been moved to select the manual-focusing mode, the user may rotate the ring 3 to adjust the focus. When Step S8 is completed, the operation returns to Step S1.

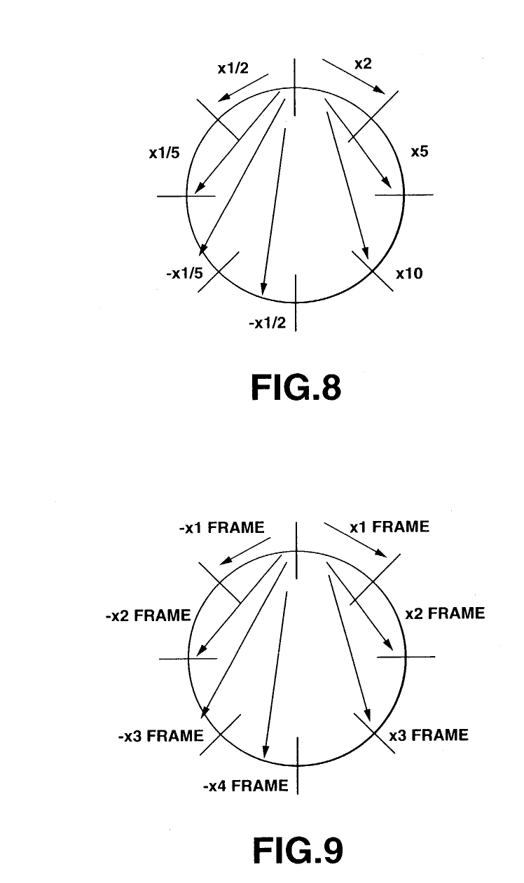

How the VTR 1 is controlled to make the focus ring 3 perform the shuttle-edit function will be explained, with reference to FIG. 8 and Table 1. FIG. 8 is a diagram illustrating the relation between the angle through which the ring 3 is rotated and the change in the playback speed. Table 1 shows various playback speeds that correspond to various angles through which the ring 3 may be rotated. Note that the angles are represented in units of 1.

TABLE 1

| 0 | Rew | −×10 | −×5 | −×2 | −×1 | −×1/2 | −×1/5 | ×0 | ×1/5 | ×1/2 | ×1 | ×2 | ×5 | ×10 | FF |
|---|---|---|---|---|---|---|---|---|---|---|---|---|---|---|---|
| +1 | × | −×5 | −×2 | −×1 | −×1/2 | −×1/5 | ×1/5 | × | ×1/2 | ×1 | ×2 | ×5 | ×10 | ×10 | × |
| +2 | × | −×2 | −×1 | −×1/2 | −×1/5 | ×1/5 | ×1/2 | × | ×1 | ×2 | ×5 | ×10 | ×10 | ×10 | × |
| +3 | × | −×1 | −×1/2 | −×1/5 | ×1/5 | ×1/2 | ×1 | × | ×2 | ×5 | ×10 | ×10 | ×10 | ×10 | × |
| +4 | × | −×1/2 | −×1/5 | ×1/5 | ×1/2 | ×1 | ×2 | × | ×5 | ×10 | ×10 | ×10 | ×10 | ×10 | × |
| +5 | × | −×1/5 | ×1/5 | ×1/2 | ×1 | ×2 | ×5 | × | ×10 | ×10 | ×10 | ×10 | ×10 | ×10 | × |
| +6 | × | ×1/5 | ×1/2 | ×1 | ×2 | ×5 | ×10 | × | ×10 | ×10 | ×10 | ×10 | ×10 | ×10 | × |
| +7 | × | ×1/2 | ×1 | ×2 | ×5 | ×10 | ×10 | × | ×10 | ×10 | ×10 | ×10 | ×10 | ×10 | × |
| +8 | × | ×1 | ×2 | ×5 | ×10 | ×10 | ×10 | × | ×10 | ×10 | ×10 | ×10 | ×10 | ×10 | × |
| +9 | × | ×2 | ×5 | ×10 | ×10 | ×10 | ×10 | × | ×10 | ×10 | ×10 | ×10 | ×10 | ×10 | × |
| +10 | × | ×5 | ×10 | ×10 | ×10 | ×10 | ×10 | × | ×10 | ×10 | ×10 | ×10 | ×10 | ×10 | × |
| +11 | × | ×10 | ×10 | ×10 | ×10 | ×10 | ×10 | × | ×10 | ×10 | ×10 | ×10 | ×10 | ×10 | × |

When the focus ring 3 is quickly rotated in the positive direction as shown in FIG. 8, in the ordinary playback mode, the speed of reproducing the image signal changes to ×2, ×5 and ×10. When the focus ring 3 is quickly rotated in the negative direction as shown in FIG. 8, the speed of reproducing the image signal changes to ×½, ×⅕, −×⅕, and −×1/2. As the ring 3 is further rotated, the speed changes to the values that are shown in Table. 1.

Table 1 shows how the speed changes as the ring 3 is rotated in the positive direction. If the ring 3 is rotated in the negative direction, the speed will change in the reverse order. As seen from Table 1, the angles of rotation are detected in regular units. Nonetheless, the units of angles to be detected may be customized on the basis of the characteristics of the apparatus. For example, we may render it difficult to detect angles at the first stage, and any angle detected only once after the fifth stage may be neglected. Alternatively, any angle detected once may be regarded as having been changed by one unit only. Further, the units of angles to be detected may be increased to make it easy to start the reproduction of the image signal at normal speed.

How the focus ring 3 performs the jog-dial function will be explained, with reference to FIG. 9. The jog-dial function is to change the number of frames that are fed forward (or backward), in accordance with the angle through which the ring 3 is rotated when the image signal is reproduced at normal speed. Angles of rotation are detected in regular units. The units of angles may be customized in accordance with the characteristics of the apparatus. For example, we may render it difficult to detect angles at the first stage, and any angle detected only once after the fifth stage may be neglected. Alternatively, any angle detected once may be regarded as having been changed by one unit only. Thus, the units of angles are changed on the basis of the characteristics of the apparatus.

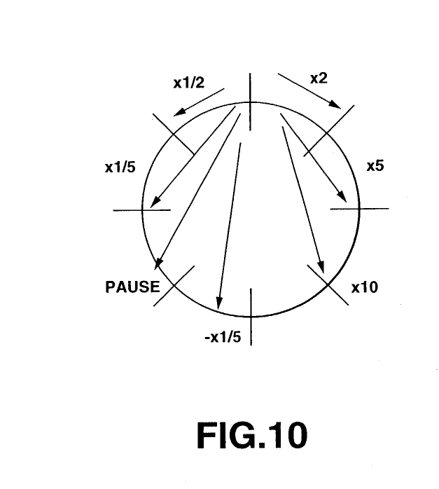

How the apparatus is controlled not to alter the speed-changing ring function despite an interruption of playback, with reference to FIG. 10. The two modes of control, described with reference to FIG. 8 and FIG. 9, respectively, may be combined. Nonetheless, the feeding of frames can be started again, usually with the frame nearest to the first frame at which an angle of rotation is detected for the first time after the interruption of playback. This means that the frame feeding can be started only when the playback is interrupted, thereby not altering the speed-changing ring function. The playback interruption is set between the signal-reproducing speeds ×1/5 and −⅕.

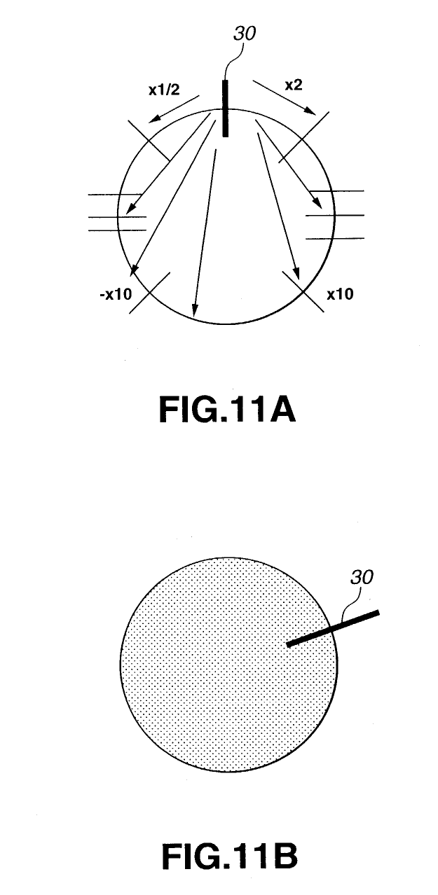

How to alter the speed-changing ring function in accordance with the center position will be explained, with reference to FIG. 11. The method described with reference to FIGS. 8 to 10 is performed on the basis of relative changes in the playback conditions. Another method can be employed, which controls the speed-changing ring function by using the absolute position that the ring 3 takes after the shuttle-edit function is effected during the variable-speed playback.

Hitherto, there are no other ways than to rotate the ring to the initial position or depress the reproduction key or the like, in order to resume the normal playback conditions. In this invention, the signal-reproducing speed is changed in accordance with the absolute position that the ring assumes when the user touches the shuttle.

More specifically, the shuttle motor is controlled to set the ring at the prescribed position (or mark 30) as shown in FIG. 11A. When the user rotates the ring to the center position, he or she can feel a special “click.” Moreover, a mechanism is provided, which rotates the ring back to the prescribed position when the user cancels the variable-speed playback. Further, the relative position that the shuttle takes is displayed on the panel monitor, as is illustrated in FIG. 11B.

As indicated above, the present embodiment, i.e., camera-incorporated VTR 1, can implement the shuttle-edit function and the jog-dial function, by using a focus ring of the existing type, while the image signal recorded on the video tape is being reproduced to be edited. Needless to say, it is not required to use buttons or switches for the shuttle-edit function or the jog-dial function. The camera-incorporated VTR 1 can enable the user to edit moving pictures at high efficiency, though it remains as small as is desired.

In the camera-incorporated VTR 1, the microprocessor 9 performs the processes represented by the flowchart of FIG. 5 to accomplish the shuttle-edit function and the jog-dial function by the use of the focus ring. To be more specific, the microprocessor 9 acquires software programs sequentially from the storage medium (not shown) such as a ROM provided in the VTR 1. The software programs describe the method of reproducing image signals, according to the present invention.

Alternatively, the microprocessor 9 may acquire the software programs from an external storage such as a memory card or via a communication medium such as a network.

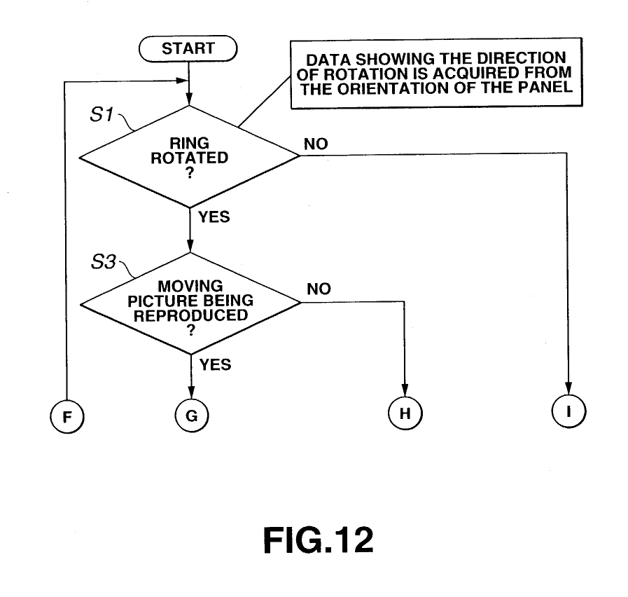

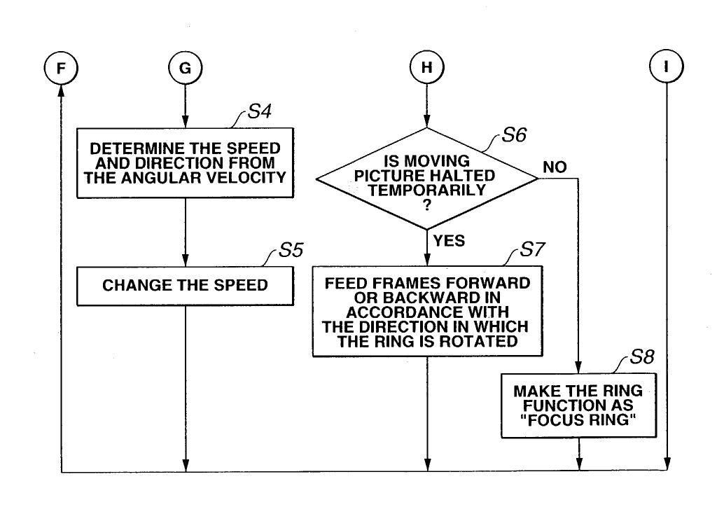

Another method of operating the camera-incorporated VTR 1 will be described with reference to the flowchart of FIG. 12, in comparison with the method illustrated in FIG. 5. This method differs from the method of FIG. 5 in that no step is performed to determine whether the VTR 1 is in the video-playback mode. Thus, if the microprocessor 9 determines in Step S1 that the focus ring 3 has been rotated, the operation goes to Step S3.

In this method, three power-supply modes, i.e., camera mode, off-mode and video mode, are not available. Namely, both camera photographing and video playback are carried out by using one and the same power supply. In Step S3, it is determined whether the moving picture can be reproduced. If YES, the operation goes to Step S4. If NO, the operation advances to Step S7.

That is, the microprocessor 9 causes the focus ring 3 to operate as a speed-changing ring if the power-supply switch has been turned on and if the focus ring 3 is rotated in the video-playback mode. At this time, the direction of rotating the speed-changing ring is reversed, as pointed out earlier, in accordance with the direction in which the LCD panel 13 has been rotated.

In Step S4, the microprocessor 9 is determined that the speed and direction of variable-speed playback, from the angular velocity of the focus ring 3 that now functions as speed-changing ring. The microprocessor 9 generates a control signal Ce for changing the playback speed. The signal Ce is supplied to the reproducing circuit 8. In Step S5, the shuttle-edit function is carried out.

In Step S3 it may be determined that the microprocessor 9 is not in the mode of reproducing moving pictures. If so, the operation goes to Step S6. In Step S6 it is determined whether the playback of the moving picture is interrupted. If YES in Step S6, the operation advances to Step S7. In Step S7, the jog-dial function is effected in accordance with the direction of rotation of the ring 3. When Step S7 ends or if it is determined in Step S6 that the playback of the moving picture is interrupted, the operation returns to Step S1.

It may be determined in Step S6 that the playback of the moving picture is not interrupted. In this case, the focus ring 3 is utilized to adjust the focus.

The VTR 1 is controlled while the shuttle-edit function and the jog-dial function are being performed by using the focus ring 3, exactly in the same manner as in the case that has been described with reference to FIGS. 8 to 11. Hence, how the VTR 1 is controlled shall not be explained here.

As indicated above, the focus ring 3 can be used in the other operating mode of the VTR 1, too, in order to perform the shuttle-edit function and the jog-dial function to reproduce the signal recorded on the video tape in the data-editing process. The camera-incorporated VTR 1 can therefore enable the user to edit moving pictures at high efficiency, though it remains as small as is desired.

The camera-incorporated VTR 1 has a storage medium (not shown) such as a ROM. The storage medium stores software programs. The microprocessor 9 acquires the software programs sequentially from the storage medium and executes them. The steps shown in the flowchart of FIG. 12 are thereby performed. Namely, the shuttle-edit function and the jog-dial function are carried out by using the focus ring. The software programs describe a specific example of an image-reproducing method according to the present invention.

In the camera-incorporated VTR 1, the software programs may be acquired from an external storage such as a memory card or via a communication medium such as a network.

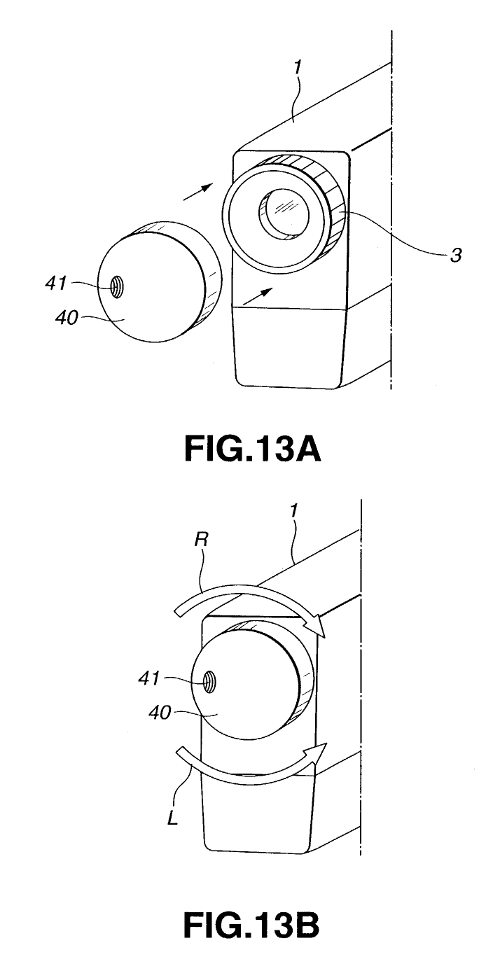

A modification of the camera-incorporated VTR 1 will be described. In the modified VTR, the focus ring 3 is covered with a cap designed for the optical lens 2 and the cap is turned to rotate the focus ring 3. More specifically, a cap 40 shown in FIG. 13A is put on the optical lens 2, thus covering the focus ring 3 as illustrated in FIG. 13B. The focus ring 3 is coupled with the cap 40 by means of a serrated mechanism. The cap 40 has a recess 41, which serves as a finger rest. The user may place the fingertip in the recess 41 and turn the cap 40 in the direction of arrow R or arrow L. As the cap 40 is so turned, the focus ring 3 is rotated in the same direction.

The present embodiment is a camera-incorporated VTR that uses videotape as recording medium and records video signals on, and reproduce video signals from, the videotape. Nevertheless, the present invention can be applied to camera-incorporated videodisk recorders that uses a disk-shaped recording medium, such as a magnetic disk or a magneto-optical disk.

In the camera-incorporated VTR 1, the focus ring 3 that operates jointly with the optical lens 2 performs the shuttle-edit function and the jog-dial function in the playback mode. A zoom ring may be used instead, to perform these functions.

In the camera-incorporated VTR 1 described above, the focus ring 3 is operated to effect the shuttle-edit function or the jog-dial function to reproduce a moving picture from a video signal. The focus ring 3 and the zoom ring can be used to perform other functions. For example, the rings may be used to record a still picture for 5 to 7 seconds in the camera-incorporated VTR or videodisk recorder.

Industrial Applicability

In the image-pickup apparatus and the method of reproducing images, both according to the present invention, the rotary ring performs not only the focusing function and the zooming function, but also the function of changing the speed of reproducing image signals. Buttons or switches need not be provided to effect, for example, the shuttle-edit function or the jog-dial function. The apparatus can therefore remain small and can yet enable the user to edit data with a high efficiency.

Further, in the image-pickup apparatus and the method of reproducing images, both according to the present invention, the rotary ring performs not only the focusing function and the zooming function, but also the function of selecting image signals. Buttons or switches need not be provided to select image signals. The apparatus can therefore remain small and can yet enable the user to edit data with a high efficiency.

1. An image-pickup apparatus comprising:
an optical lens;
a rotary ring mounted on the optical lens;
an image-pickup element for receiving an image of an object through the optical lens whose optical characteristic changes as the rotary ring is operated and for generating a video signal;
processing means for performing a camera-signal process on the video signal supplied from the image-pickup element and for outputting an image signal;
recording means for recording the image signal supplied from the processing means, in a recording medium;
reproducing means for reproducing the image signal recorded in the recording medium by the recording means; and
control means for causing the rotary ring to function as a speed-changing ring which changes the speed at which the reproducing means reproduces the image signal.

2. The image-pickup apparatus according to claim 1, wherein the control means causes the rotary ring to function as a focus ring in an image-pickup mode in which the image-pickup element receives the image of the object through the optical lens.

3. The image-pickup apparatus according to claim 2, wherein the control means switches the function between the speed-changing ring function and the focus ring function, in accordance with a key operation.

4. The image-pickup apparatus according to claim 1, wherein the control means detects activation of the reproducing means, thereby to effect the speed-changing ring function.

5. The image-pickup apparatus according to claim 4, wherein the control means feeds an image, frame by frame, as the rotary ring is rotated, upon detecting that reproducing means is temporarily stopped after activated.

6. The image-pickup apparatus according to claim 1, which further comprises an image display means connected by a coupling to the housing of the apparatus, rotatable in at least forward and reverse directions around the coupling, and designed to display an image represented by either the signal supplied from the processing means or the signal supplied from the reproducing means, and in which the control means performs a control to change the direction of operating the speed-changing ring, in accordance with an orientation of the image display means.

7. The image-pickup apparatus according to claim 3, wherein a load is applied to the rotary ring when the rotary ring functions as the speed-changing ring.

8. The image-pickup apparatus according to claim 4, wherein a load is applied to the rotary ring when the rotary ring functions as the speed-changing ring.

9. The image-pickup apparatus according to claim 3, wherein the rotary ring is set in interlock with a cap for the optical lens and is rotated when the cap is turned.

10. A method of reproducing images, in which a camera-signal process is performed on a video signal generated by an image-pickup element from an image of an object supplied to the element through an optical lens on which a rotary ring is mounted, and the image signal thus processed is recorded on a recording medium and reproduced from the recording medium,
wherein the rotary ring mounted on the optical lens is made to function as a speed-changing ring for changing a speed of reproducing the image signal from the recording medium.

11. The method of reproducing images according to claim 10, wherein the rotary ring functions as a focus ring for the optical lens, in order to guide the image of the object to the image-pickup element.

12. The method of reproducing images according to claim 10, wherein an image is fed, frame by frame, as the rotary ring is rotated, upon detecting that reproduction of the image signal from the recording medium is temporarily stopped.

13. An image-pickup apparatus comprising:
an optical lens;
a rotary ring mounted on the optical lens;
an image-pickup element for receiving an image of an object through the optical lens whose optical characteristic changes as the rotary ring is operated and for generating a video signal;
processing means for performing a camera-signal process on the video signal supplied from the image-pickup element and for outputting an image signal;
recording means for recording the image signal supplied from the processing means, in a recording medium;
reproducing means for reproducing the image signal recorded in the recording medium by the recording means; and
control means for causing the rotary ring to function as an image-selecting ring when the reproducing means reproduces the image signal.

14. The image-pickup apparatus according to claim 13, wherein the control means causes the rotary ring to function as a focus ring in an image-pickup mode in which the image-pickup element receives the image of the object through the optical lens.

15. The image-pickup apparatus according to claim 14, wherein the control means switches the function between the image-selecting ring function and the focus ring function, in accordance with a key operation.

16. The image-pickup apparatus according to claim 13, wherein the control means detects activation of the reproducing means, thereby to effect the image-selecting ring function.

17. The image-pickup apparatus according to claim 16, wherein the control means feeds an image, frame by frame, as the rotary ring is rotated.

18. The image-pickup apparatus according to claim 13, which further comprises an image display means connected by a coupling to the housing of the apparatus, rotatable in at least forward and reverse directions around the coupling, and designed to display an image represented by either the signal supplied from the processing means or the signal supplied from the reproducing means, and in which the control means performs a control to change the direction of operating the image-selecting ring, in accordance with an orientation of the image display means.

19. The image-pickup apparatus according to claim 15, wherein a load is applied to the rotary ring when the rotary ring functions as the image-selecting ring.

20. The image-pickup apparatus according to claim 16, wherein a load is applied to the rotary ring when the rotary ring functions as the image-selecting ring.

21. The image-pickup apparatus according to claim 15, wherein the rotary ring is set in interlock with a cap for the optical lens and is rotated when the cap is turned.

22. A method of reproducing images, in which a camera-signal process is performed on a video signal generated by an image-pickup element from an image of an object supplied to the element through an optical lens on which a rotary ring is mounted, and an image signal thus processed is recorded on a recording medium and reproduced from the recording medium,
wherein the rotary ring mounted on the optical lens is made to function as an image-selecting ring for selecting an image signal that is to be reproduced from the recording medium.

23. The method of reproducing images according to claim 22, wherein the rotary ring functions as a focus ring for the optical lens, in order to guide the image of the object to the image-pickup element.

24. The method of reproducing images according to claim 22, wherein an image is fed, frame by frame, as the rotary ring is rotated, when the image signal is reproduced from the recording medium.
